(19) United States
(12) Patent Application Publication
(10) Pub. No.: US 2025/0326426 A1
(43) Pub. Date: Oct. 23, 2025

(54) ELECTRIC POWER STEERING APPARATUS AND VEHICLE HAVING THE SAME

(71) Applicant: HL MANDO CORPORATION, Gyeonggi-do (KR)

(72) Inventor: Kyungmin KO, Gyeonggi-do (KR)

(21) Appl. No.: 19/176,104

(22) Filed: Apr. 10, 2025

(30) Foreign Application Priority Data
Apr. 19, 2024 (KR) 10-2024-0052740

(51) Int. Cl. B62D 5/04

(52) U.S. Cl. CPC B62D 5/0448; B62D 5/0463

(57) ABSTRACT

Provided are an electric power steering apparatus and a vehicle having the same, the electric power steering apparatus including a ball screw coupled to a steering shaft, configured to rotate, and having an outer peripheral screw groove provided in an outer peripheral surface thereof, a ball nut having an inner peripheral screw groove provided in an inner peripheral surface thereof and corresponding to the outer peripheral screw groove, having outer peripheral gear teeth provided on an outer peripheral surface thereof and coupled to a sector shaft, and configured to slide in an axial direction if the ball screw rotates, a gearbox housing in which the ball screw, the sector shaft, and the ball nut are embedded, and a nut slider coupled to the outer peripheral surface of the ball nut and configured to slide while being supported on an inner peripheral surface of the gearbox housing if the ball nut slides.

### CROSS-REFERENCE TO RELATED APPLICATION

This application claims the priority of Korean Patent Application No. 10-2024-0052740 filed on Apr. 19, 2024, in the Korean Intellectual Property Office, the disclosure of which is incorporated herein by reference in its entirety.

### BACKGROUND

### Field

The present embodiments relate to an electric power steering apparatus and a vehicle having the same.

### Description of the Related Art

In general, a steering apparatus for a vehicle refers to an apparatus that enables a driver to intentionally change a traveling direction of a vehicle, i.e., an apparatus that assists the driver in arbitrarily changing rotation centers, about which front wheels of the vehicle rotate, and allowing the vehicle to travel in a desired direction.

Meanwhile, a power-assisted steering apparatus refers to an apparatus capable of easily changing the traveling direction of the vehicle with a smaller effort by assisting a steering wheel operating force made by the driver by using a booster device if the driver operates a steering wheel of the vehicle.

The power-assisted steering apparatuses are broadly classified into an electric power steering apparatus (EPS) and a hydraulic power steering apparatus (HPS).

The hydraulic power steering apparatus refers to a steering apparatus, in which if a hydraulic pump connected to a rotary shaft of an engine supplies a working fluid to an operation cylinder connected to a rack bar, a piston of the operation cylinder, which receives the working fluid, moves and assists a steering operating force, thereby enabling the driver to perform a steering operation with a small effort.

In contrast, the electric power steering apparatus refers to a steering apparatus that has a motor instead of the hydraulic pump and the operation cylinder and assists an operating force for the steering wheel by using a force of the motor.

A truck or bus, which requires a relatively higher steering force than a passenger vehicle, employs the hydraulic steering apparatus because a high output is required. However, because no control device is provided in the hydraulic power steering apparatus, there is a problem in that it is impossible to use an automatic parking function, a lane-keeping function, an autonomous driving function, and the like using the control device.

Therefore, there is a need to transmit amplified steering torque, improve durability of power transmission components, and improve convenience of a driver while enabling a truck or bus, which requires a relatively higher steering force than a passenger vehicle, to perform an automatic parking function, a lane-keeping function, an autonomous driving function, and the like using an electronic control device.

### SUMMARY

An object of the present disclosure is to provide an electric power steering apparatus, which is capable of being applied to a truck or bus that requires a relatively higher steering force than a passenger vehicle, transmitting amplified steering torque by means of a speed reducer, improving durability of power transmission components such as a ball nut, a ball screw, a sector shaft, and a housing, and improving convenience of a driver, and a vehicle having the same.

In addition, the objects of the present embodiments are not limited thereto, and other objects, which are not mentioned above, may be clearly understood by those skilled in the art from the following descriptions.

The present embodiments may provide an electric power steering apparatus including: a ball screw operably coupled to a steering shaft, configured to be rotatable, and having an outer screw groove provided on an outer surface of the ball screw; a ball nut having an inner screw groove provided on an inner surface of the ball nut, having gear teeth provided on an outer surface of the ball nut and coupled to a sector shaft, and configured to be slidable in response to roation of the ball screw; a gearbox housing in which at least a part of the ball screw, at least a part of the sector shaft, and at least a part of the ball nut are disposed; and a nut slider coupled to the outer surface of the ball nut, supported by an inner surface of the gearbox housing, and configured to be slidable together with the ball nut.

In addition, the present embodiments may provide an electric power steering apparatus including: a ball screw operably coupled to a steering shaft, configured to be rotatable, and having an outer screw groove provided on an outer surface of the ball screw; a ball nut having an inner screw groove provided on an inner surface of the ball nut, having gear teeth provided on an outer surface of the ball nut and coupled to a sector shaft, and configured to be slidable in response to roation of the ball screw; a gearbox housing in which at least a part of the ball screw, at least a part of the sector shaft, and at least a part of the ball nut are disposed; ball circulation tubes coupled to communication holes, the communication holes provided on the outer surface of the ball nut and configured to communicate with the outer screw groove of the ball screw and the inner screw groove of the ball nut; and a tube support coupled to the outer surface of the ball nut and having an inner surface supporting the ball circulation tubes, and an outer surface supported on an inner surface of the gearbox housing.

According to the present embodiments described above, it is possible to provide the electric power steering apparatus capable of being applied to a truck or bus that requires a relatively higher steering force than a passenger vehicle, transmitting amplified steering torque by means of the speed reducer, improving the durability of the power transmission components such as the ball nut, the ball screw, the sector shaft, and the housing, and improving the convenience of the driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration view illustrating a part of a vehicle having an electric power steering apparatus according to the present embodiments;

FIG. 2 is a perspective view illustrating a part of the electric power steering apparatus according to the present embodiments;

FIG. 3 is an exploded perspective view illustrating a part of the electric power steering apparatus according to the present embodiments;

FIGS. 4 and 5 are perspective views illustrating a part of the electric power steering apparatus according to the present embodiments;

FIGS. 6 and 7 are cross-sectional views illustrating a part of electric power steering apparatus according to the present embodiments;

FIG. 8 is a perspective view illustrating a part of the electric power steering apparatus according to the present embodiments;

FIG. 9 is an exploded perspective view illustrating a part of the electric power steering apparatus according to the present embodiments; and

FIG. 10 is a cross-sectional view illustrating a part of the electric power steering apparatus according to the present embodiments.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap,” etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

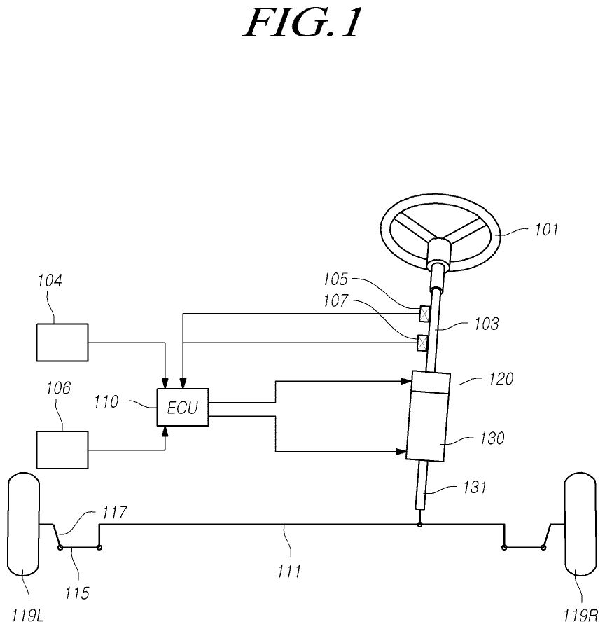

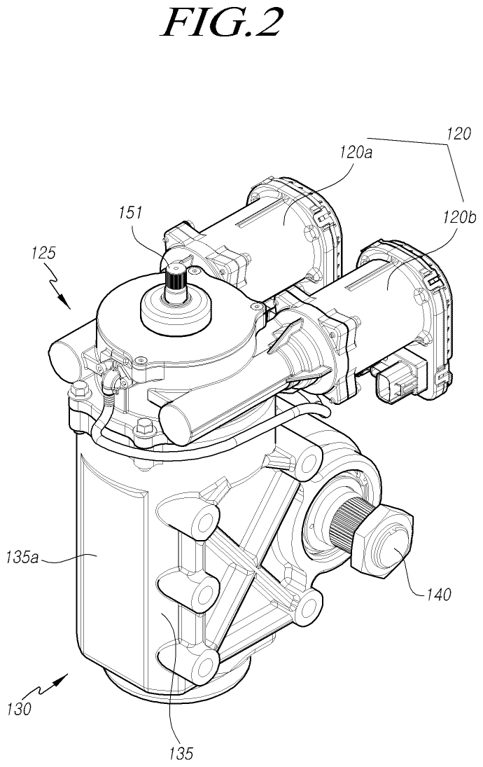

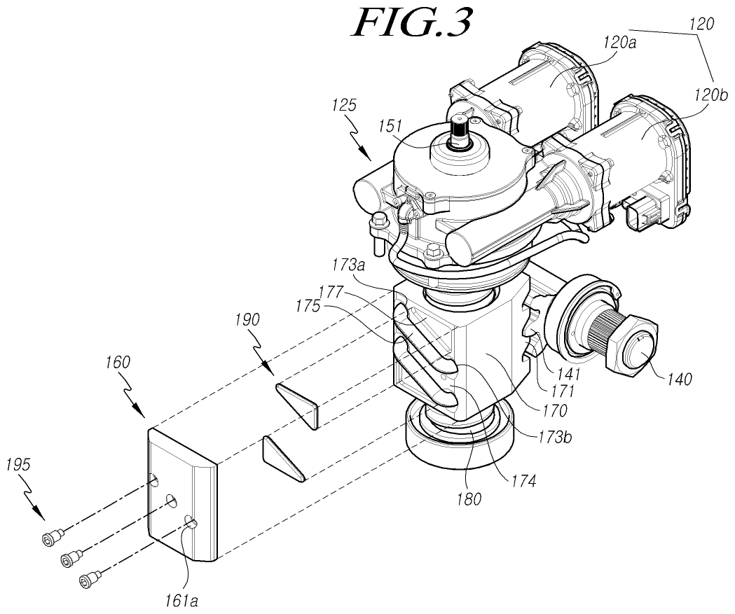

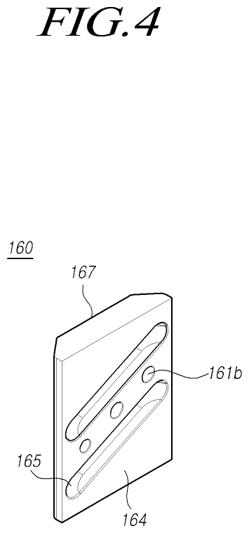

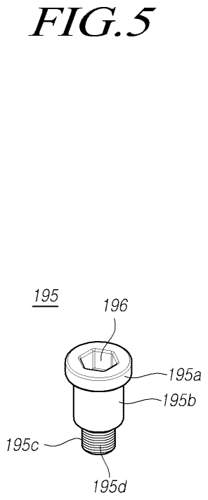

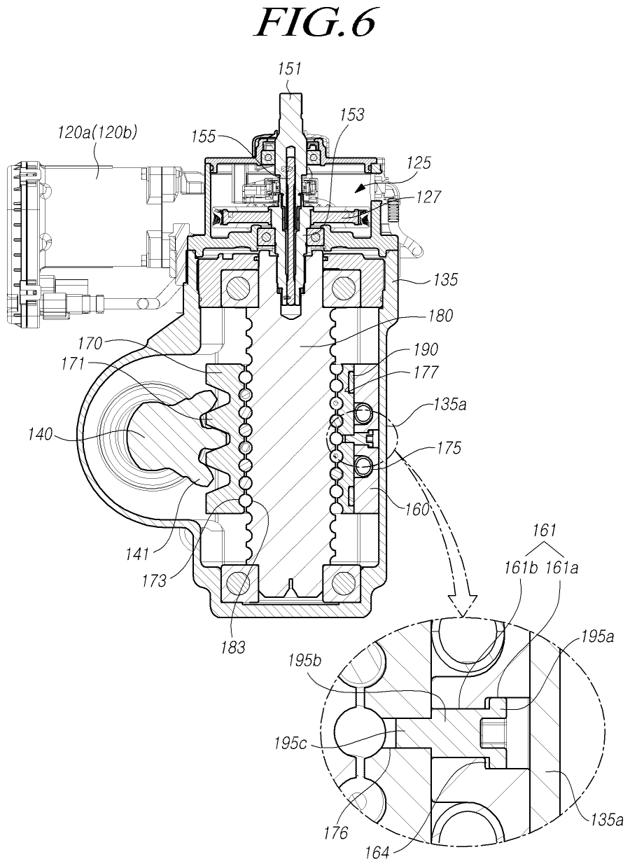

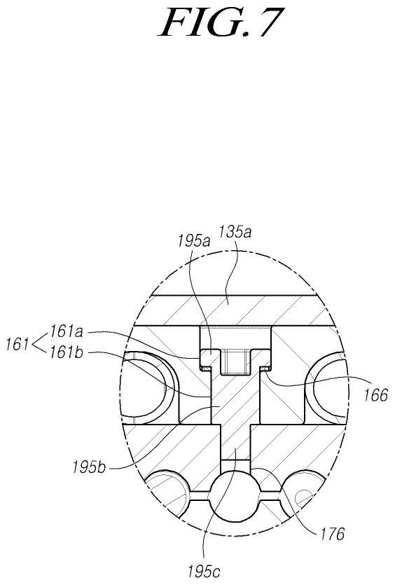

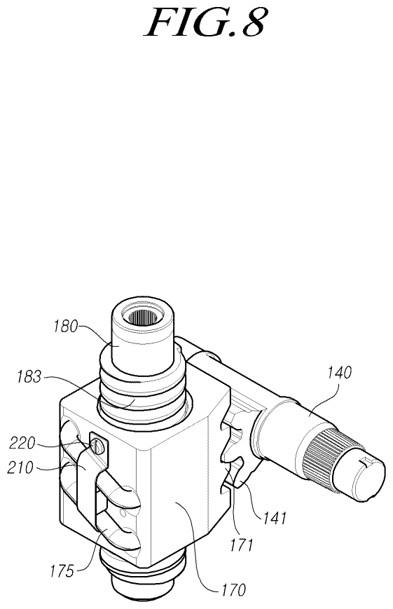

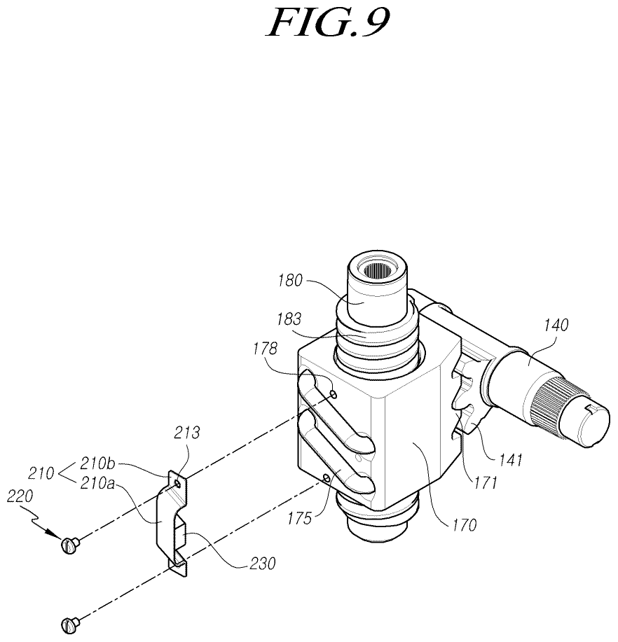

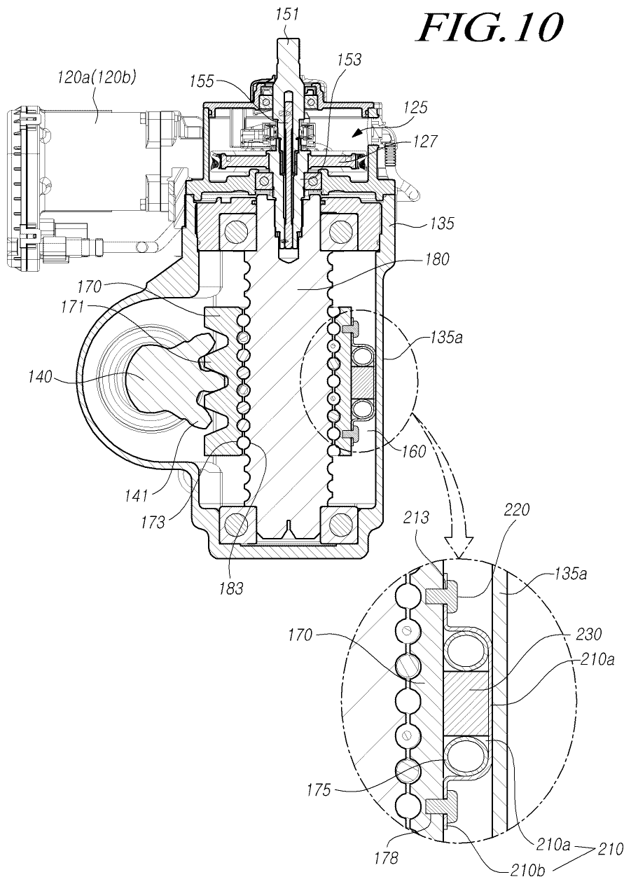

FIG. 1 is a configuration view illustrating a part of a vehicle having an electric power steering apparatus described in the present specification according to the present embodiments, FIG. 2 is a perspective view illustrating a part of the electric power steering apparatus according to the present embodiments, FIG. 3 is an exploded perspective view illustrating a part of the electric power steering apparatus according to the present embodiments, FIGS. 4 and 5 are perspective views illustrating a part of the electric power steering apparatus according to the present embodiments, FIGS. 6 and 7 are cross-sectional views illustrating a part of electric power steering apparatus according to the present embodiments, FIG. 8 is a perspective view illustrating a part of the electric power steering apparatus according to the present embodiments, FIG. 9 is an exploded perspective view illustrating a part of the electric power steering apparatus according to the present embodiments, and FIG. 10 is a cross-sectional view illustrating a part of the electric power steering apparatus according to the present embodiments.

As illustrated in these drawings, the electric power steering apparatus according to the present embodiments includes a ball screw 180 coupled to a steering shaft 103, configured to rotate, and having an outer screw groove 183 provided in an outer peripheral surface thereof, a ball nut 170 having an inner screw groove 173 provided in an inner peripheral surface thereof and corresponding to the outer screw groove 183, having gear teeth 171 provided on an outer peripheral surface thereof and coupled to a sector shaft 140, and configured to slide in an axial direction if the ball screw 180 rotates, a gearbox housing 135 in which the ball screw 180, the sector shaft 140, and the ball nut 170 are embedded, and a nut slider 160 coupled to the outer peripheral surface of the ball nut 170 and configured to slide while being supported on an inner peripheral surface of the gearbox housing 135 if the ball nut 170 slides.

First, with reference to FIGS. 1 and 2, the vehicle including the electric power steering apparatus according to the present embodiments is configured such that an angle sensor 105 and a torque sensor 107 are coupled to one side of the steering shaft 103 connected to a steering wheel 101, the angle sensor 105 and the torque sensor 107, which detect a manipulation if a driver manipulates the steering wheel 101, transmit electrical signals to an electronic control device 110, and the electronic control device 110 transmits an operational signal to a drive motor 120.

The electronic control device 110 controls the drive motor 120 based on the electrical signals transmitted from the angle sensor 105 and the torque sensor 107 and electrical signals transmitted from several sensors mounted in the vehicle.

For convenience of description, the drawings of the present embodiments illustrate that the angle sensor 105, the torque sensor 107, a vehicle speed sensor 104, and a motor rotation angle sensor 106 are provided. However, a motor position sensor for transferring steering information to the electronic control device 110 may be provided, and various types of radars, lidars, camera image sensors, and the like may be provided. Detailed descriptions of various types of sensors will be omitted.

The drive motor 120 coupled to the gearbox housing 135 may include a first drive motor 120a and a second drive motor 120b and operate a Pitman arm 131 connected to the sector shaft 140 by a gearbox 130, such that a link 111 connected to the Pitman arm 131 steers two opposite vehicle wheels 119L and 119R by means of links 115 and 117 connected to the two opposite vehicle wheels 119L and 119R.

With reference to FIGS. 2 to 7 together with FIG. 1, the ball screw 180 has the outer screw groove 183 formed in the outer peripheral surface thereof, an upper end of the ball screw 180 is coupled to the steering shaft 103, and the ball screw 180 rotates in conjunction with the steering shaft 103.

The ball nut 170 coupled to an outer peripheral side of the ball screw 180 has the gear teeth 171 formed on the outer peripheral surface thereof and has the inner screw groove 173 formed in the inner peripheral surface thereof and corresponding to the outer screw groove 183 of the ball screw 180, such that the ball nut 170 is coupled to the ball screw 180 by means of balls (no reference numeral) and slides in the axial direction.

The sector shaft 140, which is disposed in a direction perpendicular to the axial direction of the ball nut 170, has a shaft gear 141 coupled to the gear teeth 171 provided on the outer peripheral surface of one side of the ball nut 170, such that the sector shaft 140 operates the Pitman arm 131 while rotating if the ball nut 170 slides in the axial direction.

Further, the nut slider 160 coupled to the outer peripheral surface of the other side of the ball nut 170 slides in the axial direction together with the ball nut 170 while being supported on the inner peripheral surface of the gearbox housing 135.

Therefore, a force transmitted from the sector shaft 140 may be uniformly transmitted to two opposite sides of the ball nut 170, such that the ball nut 170, the ball, the bearing, and the like are prevented from being deformed and damaged, and a lifespan is prolonged.

The above-mentioned nut slider 160 may be required to have predetermined rigidity, elasticity, and wear resistance and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

As illustrated in FIG. 3, at least a pair of communication holes 173a and 173b may be provided in the outer peripheral surface of the other side of the ball nut 170 and communicate with the outer screw groove 183 and the inner screw groove 173.

Ball circulation tubes 175 are coupled to the communication holes 173a and 173b. As illustrated in FIG. 4, tube support grooves 165, in which the ball circulation tubes 175 are supported, may be provided in the inner peripheral surface of the nut slider 160.

Therefore, the ball circulation tubes 175 are seated and supported in the tube support grooves 165, such that the ball circulation tubes 175 are prevented from being shaken or vibrated by the circulation of the balls and the ball circulation tubes 175 are prevented from deviating from exact positions.

The gearbox housing 135 may have a housing support portion 135a formed as a flat inner surface at a position facing the nut slider 160.

Further, a slider support part 167 may be provided on the outer peripheral surface of the nut slider 160 and supported on the housing support portion 135a.

Therefore, a load, which occurs if the nut slider 160 slides in the axial direction together with the ball nut 170, is uniformly maintained.

Upper and lower ends of the ball screw 180 are rotatably supported on the gearbox housing 135 by bearings (no reference numeral). The ball screw 180 is coupled to the ball nut 170 by means of the balls. An elastic support 190 may be provided between the outer peripheral surface of the other side of the ball nut 170 and the inner peripheral surface of the nut slider 160 and elastically support the nut slider 160 in a radial direction.

In this case, the elastic support 190 may be made of one or more materials selected from a group consisting of natural rubber (NR), nitrile butadiene rubber (NBR), chloroprene rubber (CR), ethylene propylene terpolymer (EPDM), fluoro rubber (FPM), styrene butadiene rubber (SBR), chlorosulphonated polyethylene (CSM), polyurethane (PU), and silicone rubber in order to support the nut slider 160 in the radial direction by means of an elastic restoring force.

A coupling groove 177 to which the elastic support 190 is coupled may be provided in the outer peripheral surface of the other side of the ball nut 170.

A thickness of the elastic support 190 is larger than a depth of the coupling groove 177. As illustrated in FIG. 6, if an assembling process is completed, the elastic support 190 is elastically compressed into the coupling groove 177 and supports the nut slider 160 in the radial direction toward the gearbox housing 135 by means of an elastic restoring force.

The nut slider 160 may be coupled to the outer peripheral surface of the other side of the ball nut 170 by fastener 195.

With reference to FIGS. 5 and 6, the fastener 195 may include a head portion 195a having a tool groove 196, a body portion 195b provided below the head portion 195a and having a diameter smaller than a diameter of the head portion 195a, and a screw portion 195c provided below the body portion 195b, having a diameter smaller than the diameter of the body portion 195b, and having a threaded portion 195d formed on an outer peripheral surface thereof.

The nut slider 160 has slider holes 161 to which the fastener 195 are coupled. The slider hole 161 may have a small-diameter portion 161b into which the body portion 195b is inserted, and a large-diameter portion 161a having a larger diameter than the small-diameter portion 161b and configured such that the head portion 195a is inserted into the large-diameter portion 161a.

Further, the ball nut 170 may have a nut hole 176 to which the screw portion 195c is screw-coupled.

The fastener 195 may be coupled to the slider hole 161 and the nut hole 176 so that a clearance compensation space 164 is provided between a lower surface of the head portion 195a and a bottom surface of the large-diameter portion 161a.

Therefore, even if the nut slider 160 is abraded after durability deteriorates, the elastic support 190 may support the nut slider 160 toward the gearbox housing 135, and the nut slider 160 may be moved by the clearance compensation space 164, such that a clearance caused by the abrasion may be compensated.

In addition, as illustrated in FIG. 7, an elastic insertion member 166 may be coupled between a lower surface of the head portion 195a of the fastener 195 and a bottom surface of the large-diameter portion 161a.

In this case, the elastic insertion member 166 may be made of a material having a lower elastic modulus than that of the elastic support 190 and elastically deformed by an elastic force of the elastic support 190.

Therefore, it is possible to absorb vibration and noise occurring on the gearbox housing 135 if the nut slider 160 slides. If the nut slider 160 is abraded after durability deteriorates, the elastic support 190 supports the nut slider 160 toward the gearbox housing 135, such that the elastic insertion member 166 may be elastically deformed, and the nut slider 160 may be moved, which compensate for a clearance caused by the abrasion of the nut slider 160.

Meanwhile, with reference to FIGS. 8 to 10 together with FIGS. 1 to 7, the present embodiments may include the ball screw 180 coupled to the steering shaft 103, configured to rotate, and having the outer screw groove 183 provided in the outer peripheral surface thereof, the ball nut 170 having the inner screw groove 173 provided in the inner peripheral surface thereof and corresponding to the outer screw groove 183, having the gear teeth 171 provided on the outer peripheral surface thereof and coupled to the sector shaft 140, and configured to slide in the axial direction if the ball screw 180 rotates, the gearbox housing 135 in which the ball screw 180, the sector shaft 140, and the ball nut 170 are embedded, the ball circulation tubes 175 coupled to at least one pair of communication holes 173a and 173b, the communication holes 173a and 173b being provided in the outer peripheral surface of the ball nut 170 and configured to communicate with the outer screw groove 183 and the inner screw groove 173, and a tube support member 210 coupled to the outer peripheral surface of the ball nut 170 and having an inner peripheral surface supported on the ball circulation tube 175 and an outer peripheral surface supported on the inner peripheral surface of the gearbox housing 135.

In this case, because the ball screw 180, the ball nut 170, the gearbox housing 135, and the like are identical to those described above, detailed descriptions thereof will be omitted.

The tube support 210 may be required to have predetermined rigidity, elasticity, and wear resistance and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

In addition, the tube support 210 may include a spacing portion 210a having an outer peripheral surface supported on the gearbox housing 135 and an inner peripheral surface spaced apart from the outer peripheral surface of the other side of the ball nut 170, and fixing portions 210b connected to two opposite ends of the spacing portion 210a and fixed to the outer peripheral surface of the other side of the ball nut 170.

The fixing portions 210b have fixing holes 213, and the outer peripheral surface of the other side of the ball nut 170 has outer peripheral holes 178 configured to communicate with the fixing holes 213, such that fixing members may be coupled to the fixing holes 213 and the outer peripheral holes 178.

The ball circulation tubes 175 may be provided as a pair of ball circulation tubes 175. The ball circulation tubes 175 may be respectively disposed at two opposite sides in the spacing portion 210a.

Therefore, the ball circulation tubes 175 are seated and supported inside the spacing portion 210a, such that the ball circulation tubes 175 are prevented from being shaken or vibrated by the circulation of the balls and the ball circulation tubes 175 are prevented from deviating from exact positions.

An elastic member 230 may be provided between the outer peripheral surface of the other side of the ball nut 170 and the spacing portion 210a and elastically support the spacing portion 210a.

The elastic member 230 may be made of one or more materials selected from a group consisting of natural rubber (NR), nitrile butadiene rubber (NBR), chloroprene rubber (CR), ethylene propylene terpolymer (EPDM), fluoro rubber (FPM), styrene butadiene rubber (SBR), chlorosulphonated polyethylene (CSM), polyurethane (PU), and silicone rubber.

A thickness of the elastic member 230 is larger than a distance between the spacing portion 210a and the ball nut 170. As illustrated in FIG. 9, if the assembling process is completed, the elastic member 230 is elastically compressed between the spacing portion 210a and the ball nut 170 and supports the spacing portion 210a in the radial direction toward the gearbox housing 135 by means of an elastic restoring force.

Therefore, a load, which occurs if the tube support 210 slides in the axial direction together with the ball nut 170, is uniformly maintained.

In the vehicle including the electric power steering apparatus described above, the electronic control device 110 controls the drive motor 120 based on various types of electrical signals transmitted from the vehicle speed sensor 104, the motor rotation angle sensor 106, and the like in addition to the electrical signals transmitted from the angle sensor 105 and the torque sensor 107.

The steering shaft 103 may include an input shaft 151 and an output shaft 153 and be rotated by a speed reducer 125 connected between the drive motor 120 and the steering shaft 103. If the steering shaft 103 is provided integrally in accordance with an engine room layout of the vehicle, the steering shaft 103 may serve as the input shaft 151. If two or more steering shafts 103 are provided to be bent by universal joints and the like, the steering shaft 103 may be connected to the input shaft 151.

Further, the input shaft 151 and the output shaft 153 are formed in hollow shapes, and a torsion bar 202 is coupled to an internal space of the input shaft 151 and an internal space of the output shaft 153. A torque sensor may be provided on the outer peripheral side of the input shaft 151 and detect steering torque generated if the driver manipulates the steering wheel.

Further, the drive motor 120 may include the first drive motor 120a and the second drive motor 120b in order to prevent a steering failure in the event of an error of the drive motor 120.

The speed reducer 125 may include a first worm (not illustrated) and a second worm (not illustrated) respectively coupled to the first drive motor 120a and the second drive motor 120b and configured to rotate, and a worm wheel 127 coupled to the first worm and the second worm and configured to rotate the output shaft 153 if the first drive motor 120a and the second drive motor 120b rotate.

According to the present embodiments described above, it is possible to provide the electric power steering apparatus capable of being applied to a truck or bus that requires a relatively higher steering force than a passenger vehicle, transmitting amplified steering torque by means of the speed reducer, improving the durability of the power transmission components such as the ball nut, the ball screw, the sector shaft, and the housing, and improving the convenience of the driver.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. An electric power steering apparatus comprising:
a ball screw operably coupled to a steering shaft, configured to be rotatable, and having an outer screw groove provided on an outer surface of the ball screw;
a ball nut having an inner screw groove provided on an inner surface of the ball nut, having gear teeth provided on an outer surface of the ball nut and coupled to a sector shaft, and configured to be slidable in response to roation of the ball screw;
a gearbox housing in which at least a part of the ball screw, at least a part of the sector shaft, and at least a part of the ball nut are disposed; and
a nut slider coupled to the outer surface of the ball nut, supported by an inner surface of the gearbox housing, and configured to be slidable together with the ball nut.

2. The electric power steering apparatus of claim 1, wherein the outer surface of the ball nut has communication holes configured to communicate with the outer screw groove of the ball screw and the inner screw groove of the ball nut, ball circulation tubes are coupled to the communication holes, and an inner surface of the nut slider has tube support grooves supporting the ball circulation tubes.

3. The electric power steering apparatus of claim 1, wherein the nut slider is made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

4. The electric power steering apparatus of claim 1, wherein the gearbox housing comprises a flat inner surfacefacing the nut slider to support the nut slider.

5. The electric power steering apparatus of claim 4, wherein an outer surface of the nut slider has a slider support part supported by the flat inner surface of the gear box housing.

6. The electric power steering apparatus of claim 4, further comprising an elastic support configured to elastically support the nut slider and positioned between the outer surface of the ball nut and an inner surface of the nut slider.

7. The electric power steering apparatus of claim 6, wherein the outer surface of the ball nut has a coupling groove to which the elastic support configured to elastically support the nut slider is coupled.

8. The electric power steering apparatus of claim 1, further comprising a fastner fixing the nut slider to the outer surface of the ball nut.

9. The electric power steering apparatus of claim 8, wherein the fastener comprises:
a head portion having a tool groove;
a body portion extended from the head portion and having a diameter smaller than a diameter of the head portion; and
a screw portion extended from the body portion and having a diameter smaller than the diameter of the body portion, wherein an outer surface of the screw portion is threaded.

10. The electric power steering apparatus of claim 9, wherein the nut slider has a slider hole to which the fastener is coupled, and the slider hole of the nut slider has a small-diameter portion in which the body portion of the fastner is disposed, and a large-diameter portion having a larger diameter than the small-diameter portion, wherein the head portion of the fastner is disposed in the large-diameter portion of the slider hole of the nut slider.

11. The electric power steering apparatus of claim 10, wherein the ball nut has a nut hole to which the screw portion of the fastner is screw-coupled.

12. The electric power steering apparatus of claim 11, wherein the head portion of the fastener is spaced apart from a stepped portion formed between the small-diameter portion and the large-diameter portion of the slider hole of the nut slider to provide a clearance compensation space.

13. An electric power steering apparatus comprising:
a ball screw operably coupled to a steering shaft, configured to be rotatable, and having an outer screw groove provided on an outer surface of the ball screw;
a ball nut having an inner screw groove provided on an inner surface of the ball nut, having gear teeth provided on an outer surface of the ball nut and coupled to a sector shaft, and configured to be slidable in response to roation of the ball screw;
a gearbox housing in which at least a part of the ball screw, at least a part of the sector shaft, and at least a part of the ball nut are disposed;
ball circulation tubes coupled to communication holes, the communication holes provided on the outer surface of the ball nut and configured to communicate with the outer screw groove of the ball screw and the inner screw groove of the ball nut; and
a tube support coupled to the outer surface of the ball nut and having an inner surface supporting the ball circulation tubes, and an outer surface supported on an inner surface of the gearbox housing.

14. The electric power steering apparatus of claim 13, wherein the tube support is made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

15. The electric power steering apparatus of claim 13, wherein the tube support comprises:
a spacing portion having an outer surface supported by the gearbox housing, and an inner surface spaced apart from the outer surface of the ball nut; and
fixing portions extended from the spacing portion and fixed to the outer surface of the ball nut.

16. The electric power steering apparatus of claim 15, wherein the fixing portion of the tube support has a fixing hole, the outer surface of the ball nut has a hole aligned with the fixing hole, and a fastner is coupled to the fixing hole of the fixing portion of the tube support and the hole of the ball nut.

17. The electric power steering apparatus of claim 15, wherein the ball circulation tubes include a pair of ball circulation tubes, and the pair of ball circulation tubes are respectively disposed at two opposite sides in the spacing portion of the tube support.

18. The electric power steering apparatus of claim 15, further comprising an elastic material elastically supporting the spacing portion of the tube support and located between the outer surface of the ball nut and the spacing portion of the tube support.

19. A vehicle comprising:
the electric power steering apparatus of claim 1;
a drive motor coupled to the gearbox housing; and
a speed reducer coupled between the drive motor and the steering shaft and configured to reduce a rotational force of the drive motor.

20. The vehicle of claim 19, further comprising:
a torque sensor configured to detect steering torque generated if a steering wheel is manipulated; and
a controller configured to compare a signal value inputted from the torque sensor with preset data and transmit the signal value to the drive motor.
